(19) United States
(12) Patent Application Publication
(10) Pub. No.: US 2026/0191153 A1
(43) Pub. Date: Jul. 9, 2026

(54) ORIGINAL-STATE OVERSEEDING METHOD FOR RESTORING DEGRADED MOWING AND GRAZING GRASSLANDS

(71) Applicant: China Agricultural University, Beijing (CN)

(72) Inventors: Yingjun ZHANG, Beijing (CN); Hao ZHANG, Beijing (CN); Jiqiong ZHOU, Beijing (CN); Gaowen YANG, Beijing (CN); Nan LIU, Beijing (CN); Meiqi GUO, Beijing (CN); Jingyu ZHOU, Beijing (CN)

(21) Appl. No.: 19/556,447

(22) Filed: Mar. 4, 2026

Related U.S. Application Data
(63) Continuation of application No. PCT/CN2024/092596, filed on May 11, 2024.

(30) Foreign Application Priority Data
May 11, 2024 (CN) 202410582026.5

(51) Int. Cl. A01G 20/00; A01C 5/06

(52) U.S. Cl. CPC A01G 20/00; A01C 5/064

(57) ABSTRACT

An original-state overseeding method for restoring degraded mowing and grazing grasslands comprises: Step 1: deep slitting: use a disc blade to move vertically downward and cut a deep slit of no less than 10 cm without ridges on the surface of the degraded grazing land; Step 2: form vertical furrows in the middle-deep strata along the slit, and use a corrugated disc to chop the soil and the root system on the inner wall of the deep slit, with a cutting depth of 6-8 cm; Step 3: prepare a seedbed in the middle strata along the vertical furrow, and use an inverted T-shaped seedbed preparator to prepare an inverted T-shaped seedbed in the lower middle part of the vertical furrow, with a seedbed depth of 4-6 cm; Step 4: blow the seeds and fertilizer along the vertical furrows, and then use a compactor to compact the seedbed.

### CROSS-REFERENCE TO RELATED APPLICATIONS

The present application is a continuation of International Application No. PCT/CN2024/092596, filed on May 11, 2024, which claims priority to Chinese Patent Application No. 202410582026.5, filed on May 11, 2024, the entire disclosure of which is incorporated herein by reference.

### TECHNICAL FIELD

The invention belongs to the technical field of forage cultivation, and particularly relates to an original-state overseeding method for restoring degraded mowing and grazing grasslands.

### BACKGROUND ART

In China, grasslands with annual rainfall exceeding 300 mm, altitude below 4,000 m and slopes less than 10 degrees that are suitable for mechanized operations cover approximately 660 million mu (about 44 million hectares). These grasslands are primarily productive hayfields and grazing lands (hereinafter referred to as mowing and grazing grasslands), serving as the primary forage source for grass-feeding livestock in pastoral areas and providing nearly one third of beef and mutton and one fourth of dairy products in China. However, mowing and grazing grasslands have long been subjected to a pattern of “low investment and intensive utilization”. Currently, over 90% of grasslands are severely degraded, with declining soil productivity and educed forage yield and quality, posing a serious threat to regional ecological security and production of livestock products.

Degraded mowing and grazing grasslands exhibit high soil compaction, and high-quality forage grass decreases or even disappears. The vegetative propagation of forage grass or the vegetation regeneration process driven by soil seed banks is hindered. It may take over a century to naturally restore and achieve improvements in soil fertility and vegetation recovery. Basic measures for restoring degraded mowing and grazing grasslands include taking agronomic measures to loosen the soil and enhance soil fertility, and reintroducing high-quality forage grasses by no-till resowing method to increase the proportion of high-quality forage grasses. Although no-till resowing technique commonly used in cultivated land can, to some extent, achieve the reintroduction of high-quality forage grass seeds, it has the following drawbacks:

Firstly, the soil in degraded grasslands is compact, and the ordinary no-till resowing method fail to achieve sufficient furrow depth, which hinders root development of the resowed forage grasses. Additionally, most conventional no-till resowing machines use cutters to directly furrow, forming V-shaped seeding furrows. This not only causes rapid wear on the furrowing components but also results in poor soil moisture preservation in the V-shaped furrows.

Secondly, forage grass seeds are small and irregularly shaped, making seed metering and delivery challenging.

Thirdly, uneven furrow depths lead to poor seedling emergence uniformity. These shortcomings contribute to low emergence and survival rates of the resowed forage grasses.

Meanwhile, competition from existing vegetation in degraded grasslands weakens the growth of resowed forage grasses during the seedling stage, making it difficult for them to store sufficient nutrients to survive the winter.

Therefore, there is an urgent need for a new method that can effectively address issues such as uneven ground surfaces, high soil compaction, poor seeding uniformity, and low survival rates of resowed forage grasses in degraded mowing and grazing grasslands.

### SUMMARY OF THE INVENTION

In response to the problems identified in the background art, the invention provides an original-state overseeding method for restoring degraded mowing and grazing grasslands, comprising:
Step 1: deep slitting: use a disc blade to move vertically downward and cut a deep slit of no less than 10 cm without ridges on the surface of the degraded grazing land; the width of the slit is less than 1.5 cm;
Step 2: form vertical furrows in the middle-deep strata along the slit, and use a corrugated disc to chop the soil and the root system on the inner wall of the deep slit, with a cutting depth of 6-8 cm;
Step 3: prepare a seedbed in the middle strata along the vertical furrow, and use an inverted T-shaped seedbed preparator to prepare an inverted T-shaped seedbed in the lower middle part of the vertical furrow, with a seedbed depth of 4-6 cm; the seedbed preparation plow of the inverted T-shaped seedbed preparator extrudes the loose soil chopped by the corrugated disc blade to form the inverted T-shaped seedbed;
Step 4: blow the seeds and fertilizer along the vertical furrows, and then use a compactor to compact the seedbed.

The surface of the disc blade is smooth and non-corrugated, and the disc blade gradually decreases in edge thickness from the center to the edge, forming a cutting edge at the outermost periphery.

A plurality of slits are arranged parallel to each other during mechanized operations, the distance between two adjacent slits is 15 cm for severely degraded grassland, 20 cm for moderately degraded grassland, and 40 cm for mildly degraded or undegraded grassland.

The width between the most convex point and the most concave point at the outer edge of the corrugated disc is 1.5-2.5 cm.

The inverted T-shaped seedbed preparator comprises a connecting rod part and a seedbed preparation plow, wherein the connecting rod part is fixedly connected above the top surface of the seedbed preparation plow, the thickness of the connecting rod part is less than the width of the vertical furrow, and the bottom surface of the seedbed preparation plow forms an angle of 15-30 degrees with the ground; the seedbed preparation plow extrudes the loose soil chopped by the corrugated disc beneath the seedbed preparation plow, thereby forming the inverted T-shaped seedbed which is narrow at the top and wide at the bottom and has effects of warming and soil moisture preservation in the lower middle part of the vertical furrow to hold forage seeds and seed fertilizer.

The seedbed preparation plow consists of a front expanded part and a rear stabilizing part which are integrally formed, wherein the front expanded part is an isosceles trapezoid from a top view, while the rear stabilizing part is rectangular from a top view, and the width of the rear stabilizing part is not more than that of the rear part of the expanded part in the left-right direction.

The front face of the connecting rod part is located behind a front end face; the front face of the expanded part is perpendicular to the direction of forward motion to minimize wear; the length of the stabilizing part is 1-2 cm in the front-rear direction, and the thickness of both the stabilizing part and the expanded part is 0.5 cm to form the seedbed.

The upper end of the inverted T-shaped seedbed preparator is fixed to a monomer profiling structure, and a seed guide tube is fixed behind the inverted T-shaped seedbed preparator to ensure consistent seeding depth; the lowest end of the inverted T-shaped seedbed preparator remains horizontal with the lowest end of the seed guide tube.

The process of blowing seeds and fertilizer is as follows: seeds and seed fertilizer are air-blown into the prepared seedbed and initially mixed with the fine soil generated during the preparation of the inverted T-shaped seedbed by the inverted T-shaped seedbed preparator, causing the loose soil above the seedbed to cover the surface of the seeds.

The process of compacting the seedbed using the compactor is as follows: the seedbed is compacted using the compactor so that the seeds inside the seedbed are in close contact with the soil above and below the seeds, facilitating water absorption and seed germination; the outer edge of the compaction wheel is U-shaped, and the thickness of the press wheel matches the width of the connecting rod of the inverted T-shaped seedbed preparator.

The invention has the following beneficial effects:
1. The method increases the depth of the slit without ridges, enhances disturbance to the soil and the root system within the slit, creates a plough layer condition similar to cultivated land with loose top and compact bottom, forms an inverted T-shaped seedbed that retains warmth and moisture, improves the uniformity of furrow depth, and precisely air-blows grass seeds into the seed furrow, thereby creating a favorable soil environment for seed germination and growth, improving the emergence rate, survival rate and wintering rate of forage grasses, and enhancing the success rate of restoring degraded mowing and grazing grasslands. The sequence of furrowing components is as follows: disc blade, corrugated disc, inverted T-shaped seedbed preparator+seed guide tube, and compactor. These furrowing components are arranged in line, with the very bottom of the disc blade lower than that of the corrugated disc, and the very bottom of the corrugated disc lower than that of the inverted T-shaped seedbed preparator+seed guide tube. The method achieves zero ridge in degraded mowing and grazing grasslands, minimizing damage to the grasslands.
2. The corrugated disc is designed to further cut the soil and the root systems of existing plants within the slit, thereby maximizing disturbance to the soil and roots, preparing a plough layer condition similar to farmland soil with loose top and compact bottom, effectively reducing competitive exclusion of resowed forage grasses by existing grassland vegetation and promoting the establishment of resowed forage grasses. Meanwhile, the chopped soil fills in gaps at greater depths within the slit, preventing seeds from falling to the very bottom of the slit where they cannot germinate.
3. The method provides a favorable soil environment for the germination, rooting and aerial growth of resowed forage grasses, avoids competition with native vegetation, promotes the growth of resowed forage grasses during the seedling stage, and accelerates their photosynthetic carbon assimilation; the method addresses the issue that the forage grasses have difficulty in absorbing soil mineral elements during seedling stage due to slow root growth, enabling the roots of resowed forage grasses to store sufficient nutrients for overwintering, increasing the establishment success rate of resowed forage grasses, offering technical support for vegetation restoration and productivity improvement in degraded mowing and grazing grasslands, and holding significant application value and wide popularization prospect.

### BRIEF DESCRIPTION OF THE DRAWINGS

FIG. 1 is a flow diagram of the embodiment of the original-state overseeding method for restoring degraded mowing and grazing grasslands according to the invention.

FIG. 2 is a schematic diagram of the narrow slit cut by the disc blade in the embodiment of the invention.

FIG. 3 is a schematic diagram of the soil and the root system chopped by the corrugated disc in the embodiment of the invention.

FIG. 4 is a schematic diagram of the seedbed prepared by the inverted T-shaped seedbed preparator and the position of seeds and seed fertilizer within the seedbed in the embodiment of the invention.

FIG. 5 is a schematic diagram of the seedbed compacted by the compactor in the embodiment of the invention.

FIG. 6 is a comparison diagram of the operating depths of all steps in the embodiment of the invention.

FIG. 7 is a structural diagram of the inverted T-shaped seedbed preparator in the embodiment of the invention.

FIG. 8 is a side view of the inverted T-shaped seedbed preparator in the embodiment of the invention.

FIG. 9 is a diagram illustrating the thermal insulation and soil moisture preservation effects of the inverted T-shaped seedbed preparator in the embodiment of the invention.

FIG. 10 is a diagram illustrating the thermal insulation and soil moisture preservation temperature effects of the inverted T-shaped seedbed preparator in the embodiment of the invention.

### REFERENCE SIGNS

1. Soil; 2. Fine soil and the roots chopped by corrugated disc; 3. Fine soil generated during seedbed preparation by inverted T-shaped seedbed preparator; 4. Forage seeds and seed fertilizer; 5. Soil compacted by compactor; 6. Compactor; 7. Disc blade; 8. Corrugated disc; 9. Inverted T-shaped seedbed preparator; 91. Connecting rod part; 92. Seedbed preparation plow; 921. Front end face; 922. Expanded part; 923. Stabilizing part; 10. Seed guide tube; a. Slit width; b. Slit depth; c. Vertical furrow width after soil and the roots are chopped by corrugated disc; d. Vertical furrow depth after soil and the roots are chopped by corrugated disc; e. Seedbed depth; f. Seedbed Bottom width.

### DETAILED DESCRIPTION OF THE INVENTION

The invention is described in detail in conjunction with the drawings.

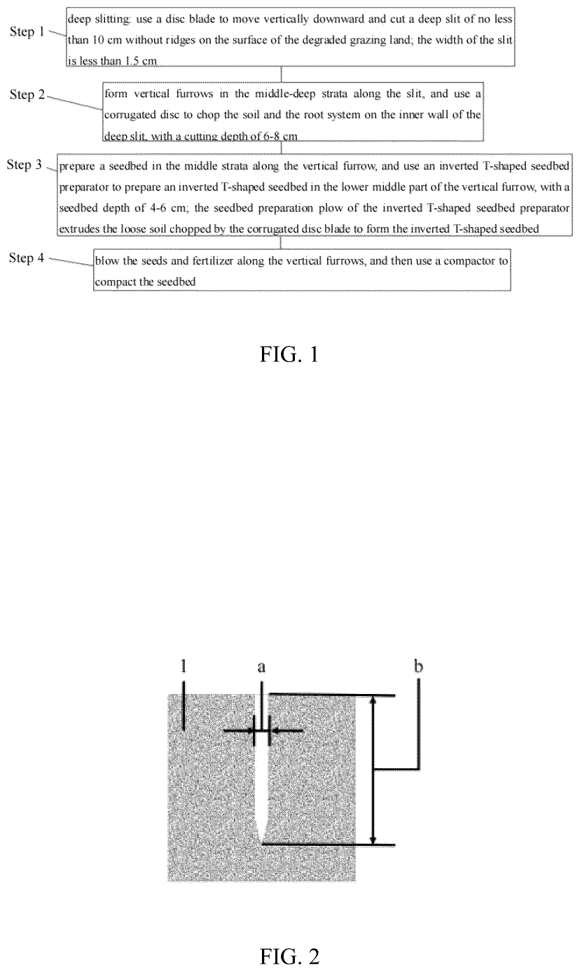

The embodiment of the invention shown in FIGS. 1-8 comprises:
Step 1: deep slitting: use a disc blade to move vertically downward and cut a deep slit of no less than 10 cm without ridges in the soil 1; the surface of the disc blade is smooth and non-corrugated, and the disc blade gradually decreases in edge thickness from the center to the edge, forming a cutting edge at the outermost periphery; meanwhile, the slit width does not exceed 1.5 cm; as shown in FIG. 2, the deep slit has a width a less than 1.5 cm, preferably 1 cm, and a depth b more than 10 cm.

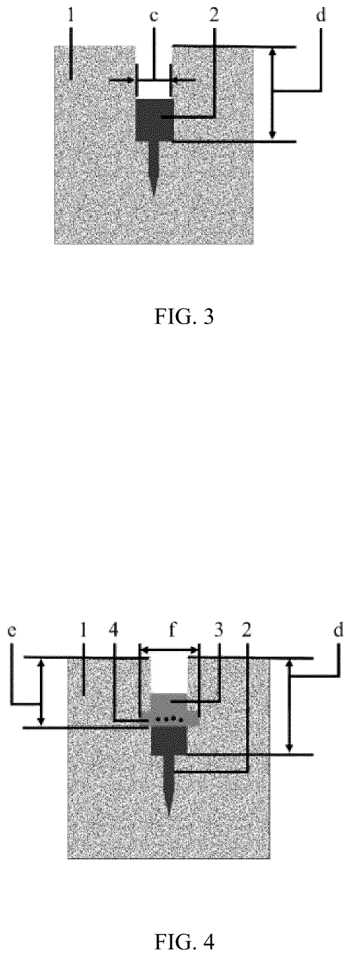

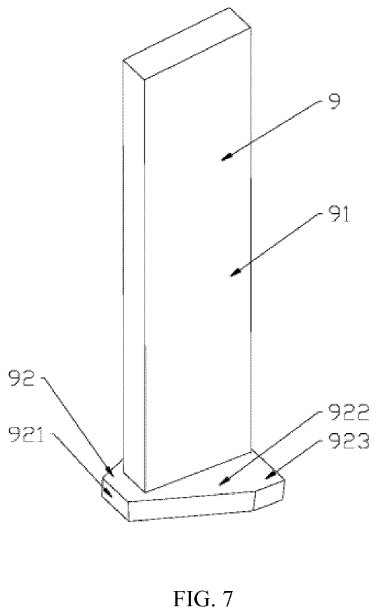

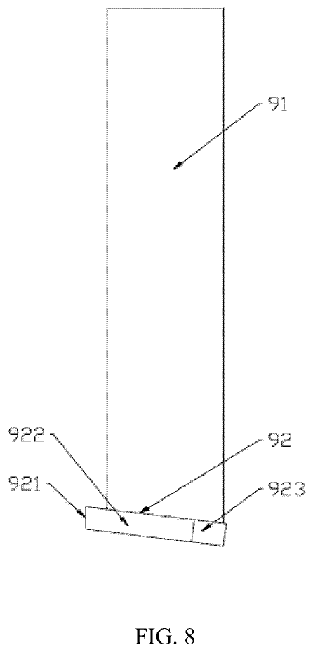

A plurality of slits are arranged parallel to each other during mechanized operations, the distance between two adjacent slits is 15 cm for severely degraded grassland, 20 cm for moderately degraded grassland, and 40 cm for mildly degraded or undegraded grassland.
Step 2: form vertical furrows in the middle-deep strata along the slit, and use a corrugated disc to chop the soil and the root system on the inner wall of the deep slit, with a cutting depth of 6-8 cm, preferably 7 cm. As shown in FIG. 3, the upper part of the deep slit is widened to some extent by leveraging the compact nature of soil in degraded grasslands. The chopped soil and the root systems fall into the bottom of the deep slit by gravity, forming the vertical furrow suitable for sowing. The width between the most convex point and the most concave point at the outer edge of the corrugated disc is 1.5-2.5 cm, preferably 2 cm. FIG. 3 shows the condition after the soil and the root system are chopped by the corrugated disc. The chopping width c matches the width of the corrugated disc, ranging from 1.5 to 2.5 cm; the chopping depth d is 6-8 cm; the fine soil and root system 2 chopped by the corrugated disc are located at the bottom of the vertical furrow.
Step 3: prepare a seedbed in the middle strata along the vertical furrow, and use an inverted T-shaped seedbed preparator 9 to prepare an inverted T-shaped seedbed in the lower middle part of the vertical furrow in the middle strata 4-6 cm from the earth surface, with a seedbed depth of 4-6 cm, preferably 5 cm; as shown in FIGS. 7 and 8, the inverted T-shaped seedbed preparator 9 used comprises a connecting rod part 91 and a seedbed preparation plow 92, wherein the connecting rod part 91 is fixedly connected above the top surface of the seedbed preparation plow 92, the thickness of the connecting rod part 91 is less than the width of the vertical furrow, and the bottom surface of the seedbed preparation plow 92 forms an angle of 15-30 degrees with the ground; the seedbed preparation plow 92 extrudes the loose soil chopped by the corrugated disc beneath the seedbed preparation plow 92, thereby forming the inverted T-shaped seedbed which is narrow at the top and wide at the bottom and has effects of warming and soil moisture preservation in the lower middle part of the vertical furrow to hold forage seeds and seed fertilizer 4.

The seedbed preparation plow 92 consists of a front expanded part 922 and a rear stabilizing part 923 which are integrally formed, wherein the front expanded part 922 is an isosceles trapezoid from a top view, with the thickness of 0.5 cm and the width of 2.5-3.5 cm in the left-right direction; the front end face 921 of the expanded part 922 is perpendicular to the direction of forward motion to minimize wear; the rear stabilizing part 923 designed to better form the seedbed is rectangular from a top view and matches the width of the rear part of the expanded part 922; the length of the stabilizing part 923 is 0.5 cm in the front-rear direction, and the thickness of the rear stabilizing part 923 is the same as that of the expanded part 922 (0.5 cm); the front face of the connecting rod part 91 is located behind the front end face 921. As shown in FIG. 4, the seedbed depth is 4-6 cm, and the lower part width of the seedbed matches the width of the seedbed preparation plow 92, which is 2.5-3.5 cm.

In this embodiment, the upper end of the connecting rod part 91 is fixed to a monomer profiling structure and can move vertically along the uneven earth surface, ensuring that the depth of the prepared seedbed remains consistent relative to the uneven earth surface, and guaranteeing uniformity in sowing depth.
Step 4: blow the seeds and fertilizer along the vertical furrows, and then use a compactor to compact the seedbed.

The process of blowing seeds and fertilizer is as follows: seeds and seed fertilizer are air-blown into the prepared seedbed and initially mixed with the fine soil 3 generated during the preparation of the inverted T-shaped seedbed by the inverted T-shaped seedbed preparator. The air blowing method overcomes the difficulties of seed metering and delivery caused by the small and irregular shape of forage grass seeds. As a result, seeds and seed fertilizer can more accurately fall into the seedbed. This not only facilitates seed germination within the improved soil structure but also prevents seed waste, enhances operation efficiency, and reduces restoration costs.

In this embodiment, the seeding rate of gramineous forage grasses on severely degraded grasslands is based on that of smooth bromegrass, 1-1.5 kg/mu. Diammonium phosphate is applied at a rate of 3 kg/mu as seed fertilizer. After successful establishment, an annual topdressing of 10-15 kg/mu of diammonium phosphate is applied. For moderately degraded grasslands, a mixture of leguminous plants (such as alfalfa) and gramineous forage grass is sown. The seeding rate of the leguminous plants is based on that of Medicago falcata L., 0.5-1.0 kg/mu. The seeding rate of the gramineous forage grasses is based on that of smooth bromegrass, 0.5-0.75 kg/mu. A cruciform sowing method is employed, sowing grasses first and then leguminous plants. For each sowing operation, 3 kg/mu of diammonium phosphate is applied as seed fertilizer. After successful establishment, an annual topdressing of 5-7 kg/mu of diammonium phosphate is applied. For mildly degraded or undegraded grasslands, leguminous plants such as alfalfa are resowed. The seeding rate is based on that of Medicago falcata L., 1.0-1.5 kg/mu. 10 kg/mu of superphosphate is applied as seed fertilizer. After successful establishment, an annual topdressing of 10-15 kg/mu of superphosphate is applied.

In this embodiment, seeds and fertilization are blown using the same seed guide tube 10. The seed guide tube is fixed to the connecting rod part 91, and the outer diameter of the seed guide tube 10 does not exceed the width of the vertical furrow. During adjustment, the lowest end of the inverted T-shaped seedbed preparator 9 remains horizontal with the lowest end of the seed guide tube 10.

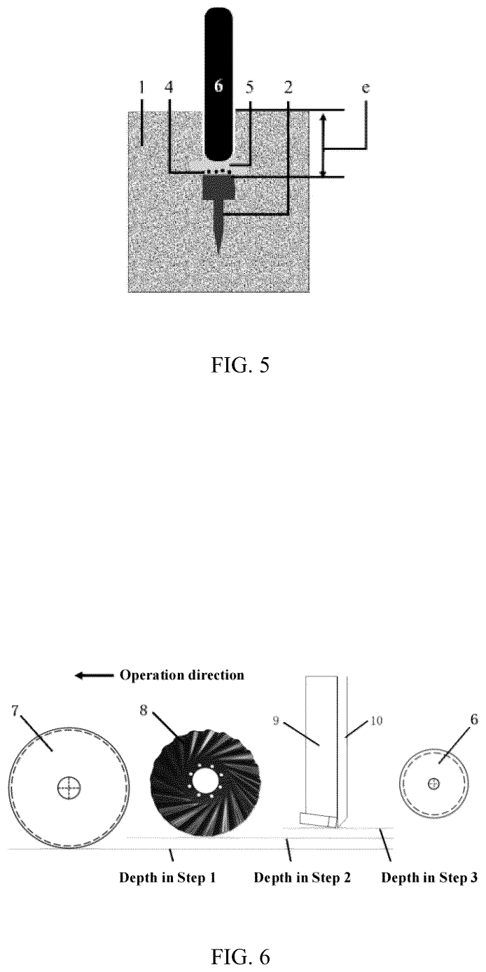

As shown in FIG. 5, the seedbed is compacted using the compactor so that the seeds inside the seedbed are in close contact with the soil above and below the seeds, facilitating water absorption and seed germination. The outer edge of the compaction wheel is U-shaped, and the thickness of the press wheel matches the width of the connecting rod of the inverted T-shaped seedbed preparator.

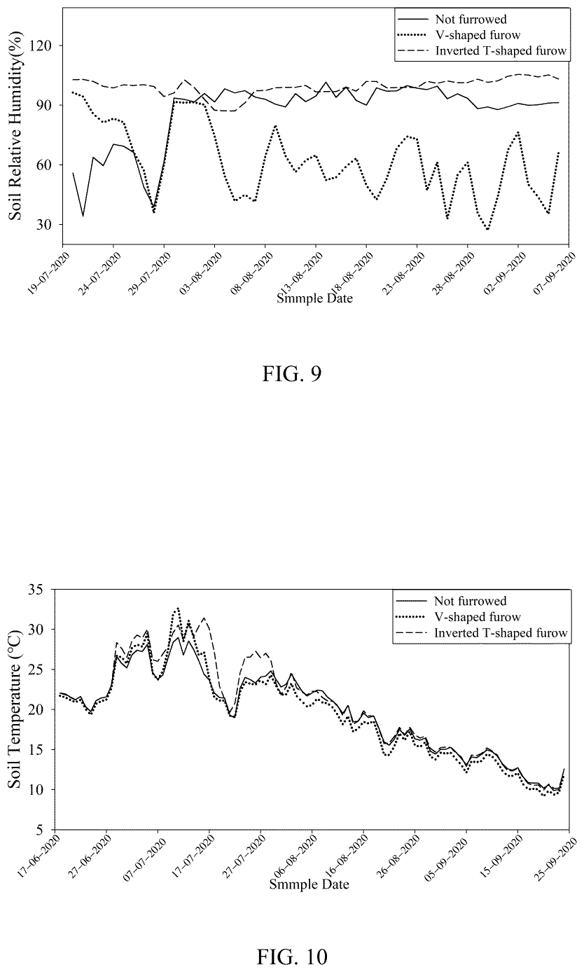

FIG. 9, FIG. 10 and Table 1 show the thermal insulation and moisture preservation of the seedbed. The monitoring period was from Jun. 17 to Sep. 6, 2020. The monitoring location was Team 9, Tenihe Agricultural and Pastoral Farm, Chen Barag Banner, Inner Mongolia Autonomous Region. Compared to the seedbed prepared by the V-shaped furrower of the conventional no-till planter, the seedbed prepared by the inverted T-shaped furrow seeder had soil moisture increased by approximately 50%. The emergence rate and survival number of the resowed forage grasses improved by 50-100% compared to those achieved by the conventional no-till planter, showing significant enhancements in both emergence rate and uniformity.

TABLE 1
Effects of new inverted T-shaped furrow seeder
on emergence rate and survival rate

| | | Emergence | Emergence | Survival |
|---|---|---|---|---|
| Treatment | | number (/m) | rate (%) | number (/m) |
| Medicago | V-shaped | 65.53 | 28.85 | 49.26 |
| falcata L. | furrower | | | |
| | Inverted | 138.47 | 60.96 | 81.47 |
| | T-shaped | | | |
| | furrower | | | |
| Medicago | V-shaped | 43.74 | 21.18 | 41.57 |
| sativa L. | furrower | | | |
| | Inverted | 63.35 | 30.68 | 66.43 |
| | T-shaped | | | |
| | furrower | | | |

What is claimed is:

1. An original-state overseeding method for restoring degraded mowing and grazing grasslands, comprising:
Step 1: deep slitting: use a disc blade to move vertically downward and cut a deep slit of no less than 10 cm without ridges on the surface of the degraded grazing land; the surface of the disc blade is smooth and non-corrugated; the width of the slit is less than 1.5 cm;
Step 2: form vertical furrows in the middle-deep strata along the slit, and use a corrugated disc to chop the soil and the root system on the inner wall of the deep slit, with a cutting depth of 6-8 cm;
Step 3: prepare a seedbed in the middle strata along the vertical furrow, and use an inverted T-shaped seedbed preparator to prepare an inverted T-shaped seedbed in the lower middle part of the vertical furrow, with a seedbed depth of 4-6 cm; the seedbed preparation plow of the inverted T-shaped seedbed preparator extrudes the loose soil chopped by the corrugated disc blade to form the inverted T-shaped seedbed; the inverted T-shaped seedbed preparator comprises a connecting rod part (91) and a seedbed preparation plow (92), wherein the connecting rod part (91) is fixedly connected above the top surface of the seedbed preparation plow (92), the thickness of the connecting rod part (91) is less than the width of the vertical furrow, and the bottom surface of the seedbed preparation plow (92) forms an angle of 15-30 degrees with the ground; the seedbed preparation plow (92) extrudes the loose soil chopped by the corrugated disc beneath the seedbed preparation plow (92), thereby forming the inverted T-shaped seedbed which is narrow at the top and wide at the bottom and has effects of warming and soil moisture preservation in the lower middle part of the vertical furrow to hold forage seeds and seed fertilizer; the upper end of the inverted T-shaped seedbed preparator (9) is fixed to a monomer profiling structure, and a seed guide tube (10) is fixed behind the inverted T-shaped seedbed preparator (9) to ensure consistent seeding depth; the lowest end of the inverted T-shaped seedbed preparator (9) remains horizontal with the lowest end of the seed guide tube (10);
Step 4: blow the seeds and fertilizer along the vertical furrows, and then use a compactor to compact the seedbed.

2. The original-state overseeding method for restoring degraded mowing and grazing grasslands according to claim 1, wherein the disc blade gradually decreases in edge thickness from the center to the edge, forming a cutting edge at the outermost periphery.

3. The original-state overseeding method for restoring degraded mowing and grazing grasslands according to claim 1, wherein a plurality of slits are arranged parallel to each other during mechanized operations, the distance between two adjacent slits is 15 cm for severely degraded grassland, 20 cm for moderately degraded grassland, and 40 cm for mildly degraded grassland.

4. The original-state overseeding method for restoring degraded mowing and grazing grasslands according to claim 1, wherein the width between the most convex point and the most concave point at the outer edge of the corrugated disc is 1.5-2.5 cm.

5. The original-state overseeding method for restoring degraded mowing and grazing grasslands according to claim 4, wherein the seedbed preparation plow (92) consists of a front expanded part (922) and a rear stabilizing part (923) which are integrally formed, wherein the front expanded part (922) is an isosceles trapezoid from a top view, while the rear stabilizing part (923) is rectangular from a top view, and the width of the rear stabilizing part (923) is not more than that of the rear part of the expanded part (922) in the left-right direction.

6. The original-state overseeding method for restoring degraded mowing and grazing grasslands according to claim 5, wherein the front face of the connecting rod part (91) is located behind a front end face (921); the front end face (921) of the expanded part (922) is perpendicular to the direction of forward motion to minimize wear; the length of the stabilizing part (923) is 1-2 cm in the front-rear direction, and the thickness of both the stabilizing part (923) and the expanded part (922) is 0.5 cm to form the seedbed.

7. The original-state overseeding method for restoring degraded mowing and grazing grasslands according to claim 1, wherein the process of blowing seeds and fertilizer is as follows: seeds and seed fertilizer are air-blown into the prepared seedbed and initially mixed with the fine soil generated during the preparation of the inverted T-shaped seedbed by the inverted T-shaped seedbed preparator, causing the loose soil above the seedbed to cover the surface of the seeds.

8. The original-state overseeding method for restoring degraded mowing and grazing grasslands according to claim 1, wherein the process of compacting the seedbed using the compactor is as follows: the seedbed is compacted using the compactor so that the seeds inside the seedbed are in close contact with the soil above and below the seeds, facilitating water absorption and seed germination; the outer edge of the compaction wheel is U-shaped, and the thickness of the press wheel matches the width of the connecting rod of the inverted T-shaped seedbed preparator.
